(19) United States
(12) Patent Application Publication
(10) Pub. No.: US 2010/0303127 A1
(43) Pub. Date: Dec. 2, 2010

(54) Vehicle compartment wireless communications apparatus

(75) Inventors: Kiyokazu Akiyama, Okazaki-city (JP); Yuji Sugimoto, Kariya-city (JP); Michio Shamoto, Konan-city (JP); Yoshiyuki Kago, Nishio-city (JP)

Correspondence Address: HARNESS, DICKEY & PIERCE, P.L.C., P.O. BOX 828, BLOOMFIELD HILLS, MI, 48303, US

(73) Assignees: Nippon Soken, Inc., Nishio-city (JP); DENSO CORPORATION, Kariya-city (JP)

(21) Appl. No.: 12/800,659

(22) Filed: May 20, 2010

(30) Foreign Application Priority Data
May 26, 2009 (JP) 2009-126414

(51) Int. Cl. H04B 1/69

(52) U.S. Cl. 375/130; 375/E01.001

(57) ABSTRACT

It is determined whether each of several subcarriers has an adequate propagation characteristic in a first horizontally polarized wave antenna. Of the several subcarriers, a subcarrier, which is determined to have an adequate propagation characteristic in the first horizontally polarized wave antenna, is assigned with transmission data. A transmission signal containing the transmission data is thereby transmitted from the first horizontally polarized wave antenna. In addition, of the several subcarriers, a subcarrier, which is determined not to have an adequate propagation characteristic in the first horizontally polarized wave antenna, is also assigned with transmission data in either a second horizontally polarized wave antenna or a vertically polarized, wave antenna. A transmission signal containing the transmission data is thus transmitted from the second horizontally polarized wave antenna or the vertically polarized wave antenna.

### CROSS REFERENCE TO RELATED APPLICATION

The present application is based on and incorporates herein by reference Japanese Patent Application No. 2009-126414 filed on May 26, 2009.

### FIELD OF THE INVENTION

The present invention relates to a vehicle compartment wireless communications apparatus, which is arranged in a vehicle compartment having a flat internal wall or surface of a ceiling made of a metal material, for performing ultra wide band communications.

### BACKGROUND OF THE INVENTION

[Patent document 1] JP-2008-301006 A (US2008/0298341)

[Patent document 2] JP-2007-502072 A (US2005/0147076)

With respect to a short range wireless communications technology in a vehicle compartment, there is a handsfree phone call using a Bluetooth (registered trademark) communications technology between an in-vehicle handsfree apparatus and a cellular phone brought into the compartment. Further, there has been recently developed an ultra wide band communications technology, for example, to transfer video data from a display device arranged in a front area of the compartment to a display device in a rear area. The ultra wide band communications technology uses a frequency band of 528 [MHz] for one channel, which is divided into one hundred twenty eight (128) subcarriers, which are orthogonally multiplexed.

Incidentally, the vehicle compartment provides a propagation environment which is a multi-path environment inside of a surrounding metal body. The propagation characteristics differ for each of the subcarriers. A subcarrier provides a reception power remarkably lower than that of another subcarrier (called dip occurring). Thus, there may coexist within one channel a first subcarrier having a favorable (adequate) propagation characteristic and a second subcarrier having an unfavorable (inadequate) characteristic. To that end, Patent document 1 recites a configuration in which transmission data is assigned according to the propagation characteristic for every subcarrier; Patent document 2 recites a configuration in which the spatial diversity is made for every subcarrier that is assigned with transmission data, thereby improving a communications efficiency.

In the above, while the subcarrier having an adequate propagation characteristic is assigned with transmission data, the subcarrier having an inadequate propagation characteristic is assigned with no transmission data. Such a configuration uselessly consumes the frequency resource by the portion corresponding to the subcarrier which is not assigned with any transmission data, thereby posing a disadvantage to decrease the communications efficiency of the whole channel. Moreover, there is also a disadvantage that the spatial diversity, which is applied with respect to each subcarrier assigned with the transmission data, does not provide a sufficient effect.

### SUMMARY OF THE INVENTION

The present invention is made in view of the above-mentioned situation. It is an object of the present invention to provide a vehicle compartment wireless communications apparatus capable of appropriately using a frequency resource while improving a communications efficiency of the whole channel.

To achieve the above object, according to an example of the present invention, a vehicle compartment wireless communications apparatus for executing ultra wide band communications is provided in a vehicle compartment having a flat internal ceiling wall made of a metal material. The vehicle compartment wireless communications apparatus is provided as follows. At least two horizontally polarized wave antennas are configured to include a first horizontally polarized wave antenna and a second horizontally polarized wave antenna. At least one vertically polarized wave antenna is configured. A propagation characteristic determination device is configured to determine whether each of a plurality of subcarriers included in one channel of an ultra wide band has an adequate propagation characteristic. A transmission unit is configured to assign a subcarrier with transmission data so as to transmit a transmission signal containing the transmission data from one of the antennas. Herein, the propagation characteristic determination device is further configured to determine whether each of the plurality of subcarriers has an adequate propagation characteristic in the first horizontally polarized wave antenna. The transmission unit is further configured to assign a subcarrier, which is determined to have an adequate propagation characteristic in the first horizontally polarized wave antenna among the plurality of subcarriers, with transmission data so as to transmit a transmission signal containing the transmission data from the first horizontally polarized wave antenna, and assign a subcarrier, which is determined not to have an adequate propagation characteristic in the first horizontally polarized wave antenna among the plurality of subcarriers, with transmission data so as to transmit a transmission signal containing the transmission data from one of the second, horizontally polarized wave antenna and the vertically polarized wave antenna. The transmission unit thereby executes diversity by (i) the first horizontally polarized wave antenna and (ii) one of the second horizontally polarized wave antenna and the vertically polarized wave antenna.

Such a configuration enables the following. Suppose the case that there coexist a subcarrier adequate and a subcarrier inadequate in the propagation characteristic in a first horizontally polarized wave antenna. In such a case, transmission data is assigned to the subcarrier adequate in the propagation characteristic in the first horizontally polarized wave antenna and a transmission signal containing the transmission data is transmitted from the first horizontally polarized wave antenna. In addition, transmission data is also assigned to the subcarrier which is determined to be inadequate in the propagation characteristic in the first polarization antenna, thereby transmitting a transmission, signal containing the transmission data from either a second horizontally polarized wave antenna or a vertically polarized wave antenna. That is, a subcarrier assigned with no transmission data is not present; diversity is executed using (i) the first horizontally polarized wave antenna and (ii) either the second horizontally polarized wave antenna or the vertically polarized wave antenna The frequency resource can be thus effectively used without waste, thereby improving the communications efficiency of the whole channel appropriately.

In other words, the above configuration can be achieved based on the following circumstances. The vehicle compartment provides a propagation environment which is a multi-path environment inside of a surrounding metal body; in particular, the flat ceiling wall or surface can reflect an electric wave linearly with an incident angle and a reflection angle identical, thereby providing an effective transmission route of the reflected wave. The ultra wide band communications tend to have a great transmission loss in space; thus, the reflected wave undergoing reflection multiple times comes to have a long transmission route, thereby attenuating and hardly reaching. In the vehicle compartment, the direct wave and the reflected wave (undergoing only one reflection) in the flat ceiling wall are dominant; the plane of polarization is unchanged between transmission and reception. The horizontally polarized wave antenna generally, which has indirectionality towards the direction of the elevation angle, tends to easily take the reflection route directed towards the ceiling. In consideration of the above circumstances, basically, the transmission signal is transmitted from the first horizontally polarized wave antenna. In addition, the transmission data is also assigned to a subcarrier which is determined to be inadequate in the propagation characteristic in the first horizontally polarized wave antenna and a transmission signal containing the transmission data is transmitted from either a second horizontally polarized wave antenna or a vertically polarized wave antenna. The communications efficiency of the whole channel can be thereby improved appropriately.

According to another example of the present invention, a method for executing ultra wide band communications using a channel of an ultra wide band containing a plurality of subcarriers is provided in a vehicle compartment having a flat internal ceiling wall made of a metal material. Herein, the ultra wide communications use (i) at least two horizontally polarized wave antennas including a first horizontally polarized wave antenna and a second horizontally polarized wave antenna, and (ii) at least one vertically polarized wave antenna. The method comprises: determining whether each of the plurality of subcarriers has an adequate propagation characteristic in the first horizontally polarized wave antenna; assigning a subcarrier, which is determined to have an adequate propagation characteristic in the first horizontally polarized wave antenna among the plurality of subcarriers, with transmission data so as to transmit a transmission signal containing the transmission data from the first horizontally polarized wave antenna; assigning a subcarrier, which is determined not to have an adequate propagation characteristic in the first horizontally polarized wave antenna among the plurality of subcarriers, with transmission data so as to transmit a transmission signal containing the transmission data from one of the second horizontally polarized wave antenna and the vertically polarized wave antenna; and executing thereby diversity by (i) the first horizontally polarized wave antenna and (ii) one of the second horizontally polarized wave antenna and the vertically polarized wave antenna.

### BRIEF DESCRIPTION OF THE DRAWINGS

The above and other objects, features, and advantages of the present invention will become more apparent from the following detailed description made with reference to the accompanying drawings. In the drawings:

FIG. 1 is a functional block diagram according to an embodiment of the present invention;

FIG. 2 is a flowchart;

FIG. 3 is a diagram illustrating a measurement environment; and

FIG. 4 is a diagram illustrating a measurement result.

### DETAILED DESCRIPTION OF THE PREFERRED EMBODIMENTS

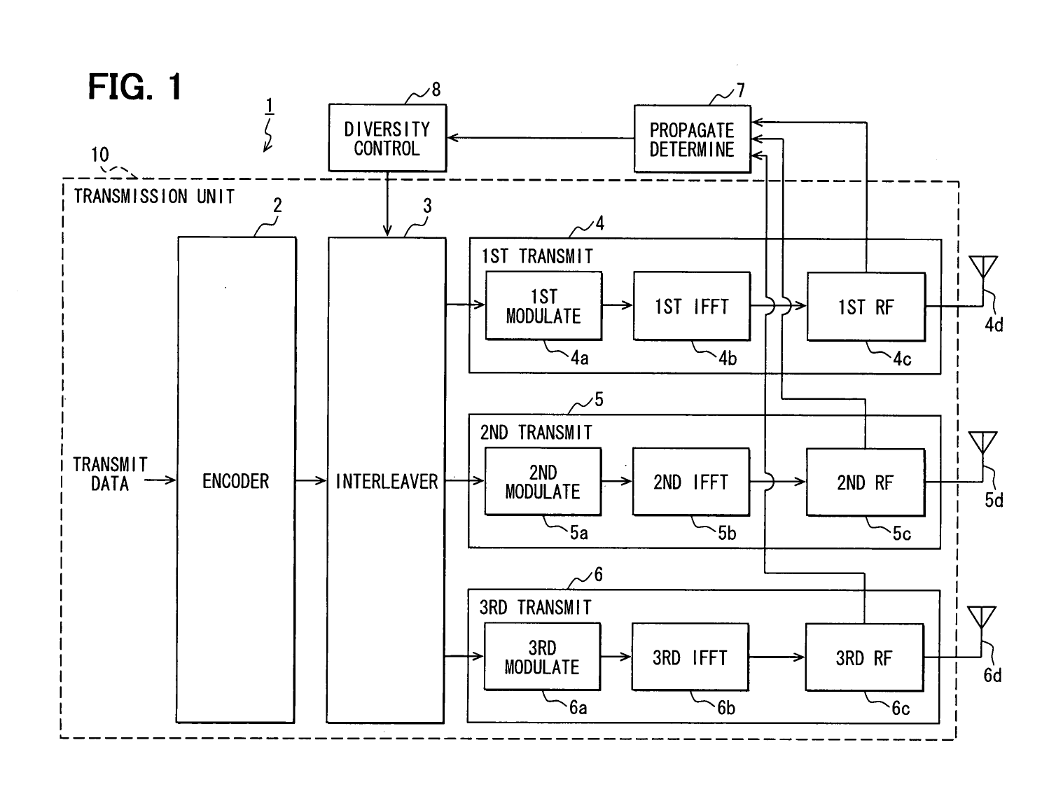

A vehicle compartment wireless communications apparatus according to an embodiment of the present invention is explained with reference to drawings. FIG. 1 illustrates main functional blocks of the vehicle compartment wireless communications apparatus 1, which is provided in a vehicle. The vehicle compartment wireless communications apparatus 1 includes a transmission unit 10, a propagation characteristic determination device 7, a diversity control circuit 8, and first to third antennas 4d, 5d, 6d. The transmission unit 10 (also referred to as a signal transmitting means) includes the following: an encoder 2; an interleaver 3; a first signal transmission device 4; a second signal transmission device 5; and a third signal transmission device 6. The propagation characteristic determination device 7 is also referred to as a propagation characteristic determining means. The diversity control circuit 8 is also referred to as a diversity controlling means. Further, the vehicle compartment wireless communications apparatus 1 may further include an in-vehicle navigation apparatus. Such an in-vehicle navigation apparatus may include the following functions: a function to specify a present position of the vehicle; a function to designate a destination; a function to read out map data; a function to perform map matching of the present position of the vehicle on the map data; a function to retrieve a guidance route from the present position of the vehicle to the destination; and a function to perform route guidance for the retrieved guidance route.

The vehicle compartment wireless communications apparatus 1 performs the ultra wide band communications in which one channel uses a frequency band of 528 [MHz] and is divided into one hundred twenty eight (128) subcarriers, which are orthogonally multiplexed. The encoder 2 codes and outputs transmission data inputted from an outside according to a predetermined algorithm. The interleaver 3 outputs (i.e., distributes) alternatively the transmission data inputted from the encoder 2 to one of the first to third signal transmission devices 4 to 6.

The first signal transmission device 4 includes the following: a first modulation device 4a to perform a modulation process of transmission data inputted from the interleaver 3, and outputs the transmission data posterior to modulation; a first IFFT (inverse fast Fourier transform) device 4b to perform an inverse fast Fourier transform with respect to the transmission data posterior to modulation, which is inputted from the first modulation device 4a, and outputs transmission data posterior to IFFT; and a first RF device 4c to perform an RF process of the transmission data posterior to IFFT, which is inputted from the first IFFT device 4b, and generates a transmission signal. The transmission signal is transmitted via the first antenna 4d, which is a first horizontally polarized wave antenna. Moreover, the first RF device 4c outputs a reception power of a reception signal which the first antenna 4d receives from an outside to the propagation characteristic determination device 7.

The second signal transmission device 5 has a configuration comparable to that of the first signal transmission device 4; the configuration includes the following: a second modulation device 5a to perform a modulation process of transmission data inputted from the interleaver 3, and outputs the transmission data posterior to modulation; a second IFFT (inverse fast Fourier transform) device 5b to perform an inverse fast Fourier transform with respect to the transmission data posterior to modulation, which is inputted from the second modulation device 5a, and outputs transmission data posterior to IFFT; and a second RF device 5c to perform an RF process of the transmission data posterior to IFFT, which is inputted from the second IFFT device 5b, and generates a transmission signal. The transmission signal is transmitted via the second antenna 5d, which is a second horizontally polarized wave antenna, comparable to the above-mentioned first antenna 4d. Moreover, the second RF device 5c outputs a reception power of a reception signal which the second antenna 5d receives from an outside to the propagation characteristic determination device 7.

The third signal transmission device 6 has a configuration comparable to that of the first signal transmission device 4 or the second signal transmission device 5 except for the antenna polarization characteristic. The third signal transmission device 6 includes the following: a third modulation device 6a to perform a modulation process of transmission data inputted from the interleaver 3, and outputs the transmission data posterior to modulation; a third IFFT (inverse fast Fourier transform) device 6b to perform an inverse fast Fourier transform with respect to the transmission data posterior to modulation, which is inputted from the third modulation device 6a, and outputs transmission data posterior to IFFT; and a third RF device 6c to perform an RF process of the transmission data posterior to IFFT which is inputted from the third IFFT device 6b, and generates a transmission signal. The transmission signal is transmitted via the third antenna 6d, which is a vertically polarized wave antenna. Moreover, the third RF device 6c outputs a reception power of a reception signal, which the third antenna 6d receives from an outside, to the propagation characteristic determination device 7.

The first antenna 4d, the second antenna 5d, and the third antenna 6d are contained or built inside of a housing of the vehicle compartment wireless communications apparatus 1 while having respectively directionality towards a ceiling of the vehicle or vehicle compartment.

The propagation characteristic determination device 7 makes a first comparison determination to compare the reception power inputted from the first RF device 4c with a predetermined first reference value (i.e., first threshold value) to thereby make a determination as to whether the propagation characteristic of the reception signal, which the first antenna 4d received from the outside, is adequate or inadequate. The propagation characteristic determination device 7 further makes a second comparison determination to compare the reception power inputted from the second RF device 5c with a predetermined second reference value (i.e., second threshold value) to thereby make a determination as to whether the propagation characteristic of the reception signal, which the second antenna 5d received from the outside, is adequate or inadequate. The propagation characteristic determination device 7 yet further makes a third comparison determination to compare the reception power inputted from the third RF device 6c with a predetermined third reference value (i.e., third threshold value) to thereby make a determination as to whether the propagation characteristic of the reception signal, which the third antenna 6d received from the outside, is adequate or inadequate. The results from the above comparison determinations are outputted to the diversity control circuit 8. It is noted that the first reference value, the second reference value, and the third reference value may be defined as being identical to each other or different from each other.

Further, based on the results of the determinations inputted from the propagation characteristic determination device 7, the diversity control circuit 8 determines an assignment of transmission data to subcarriers to thereby output an assignment instruction to the interleaver 3. Based on the assignment instruction inputted from the diversity control circuit 8, the interleaver 3 selects one signal transmission device from among the first to third signal transmission devices 4 to 6 and outputs the transmission data inputted from the encoder 2 to the selected signal transmission device 4, 5, or 6.

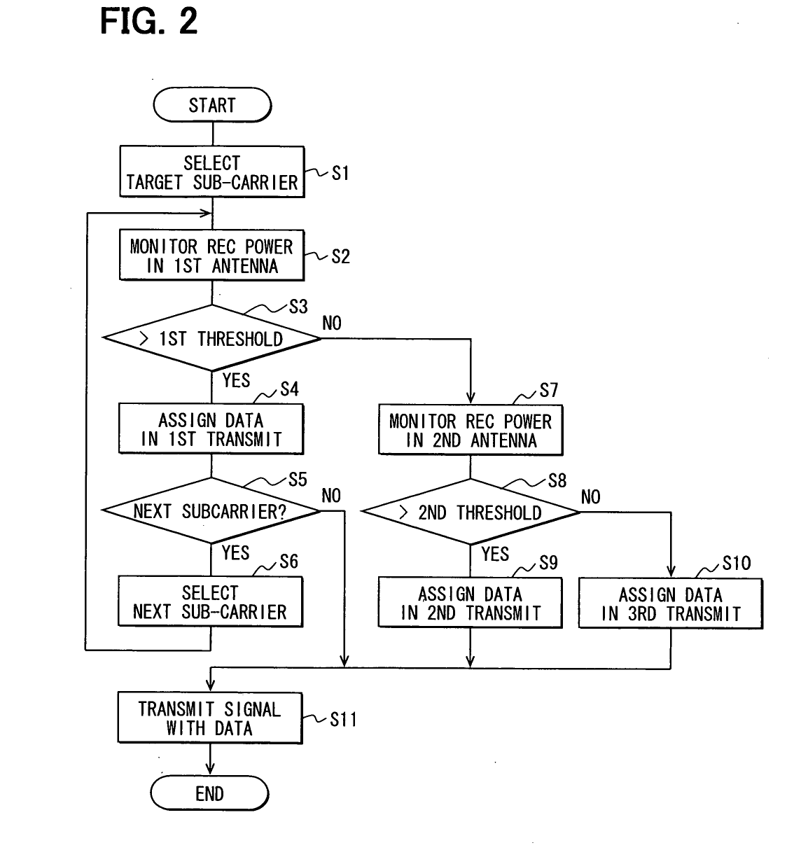

An operation under the above configuration is explained with reference to FIGS. 2 to 4. The vehicle compartment wireless communications apparatus 1 (hereinafter referred to as the apparatus 1) executes, as a main process, a process as follows. It is further noted that a flowchart or the processing of the flowchart in the present application includes sections (also referred to as steps), which are represented, for instance, as S1. Further, each section can be divided into several sub-sections while several sections can be combined into a single section. Furthermore, each of thus configured sections can be referred to as a means or unit and achieved not only as a software device but also as a hardware device. At S1, as a target subcarrier, a subcarrier is selected which has, for instance, a lowest frequency in the reception signal received via the first antenna 4d of the horizontally polarized wave antenna. At S2, the reception power in the first antenna 4d with respect to the target subcarrier is monitored in the first RF device 4c. At S3, a first comparison determination is made to compare a reception power of the monitored target subcarrier with a first reference value in the propagation characteristic determination device 7 to thereby make a determination as to whether the propagation characteristic in the first antenna 4d with respect to the target subcarrier is adequate.

When the reception power of the target subcarrier is greater than the first reference value, the first determination is affirmatively made that the propagation characteristic in the first antenna 4d with respect to the target subcarrier is adequate. At S4, a data assignment control is made in the diversity control circuit 8 such that transmission data is outputted to the first signal transmission device 4, thereby assigning the transmission data to the subcarrier, which is determined to have an adequate propagation characteristic, in the first signal transmission device 4. At S5, a determination is made as to whether there is any adjacent subcarrier which has, for instance, a frequency higher than that of the present first target subcarrier, to thereby make a determination whether there is any next target subcarrier.

When the determination at S5 is affirmatively made that there is an adjacent subcarrier which has, for instance, a frequency higher than that of the present first target subcarrier to thereby-affirmatively make the determination that there is a next target subcarrier, the adjacent subcarrier which has a higher frequency is selected as a next target subcarrier at S6. Then, the processing from above-mentioned S2 is repeated. That is, the vehicle compartment wireless communications apparatus 1 has the following configuration: it is determined whether the propagation characteristic in the first antenna 4d is adequate or not with respect to each of several subcarriers; the subcarrier, which is determined to have an adequate propagation characteristic, is assigned with transmission data in the first signal transmission device 4; and in contrast, while the subcarrier, which is determined not to have an adequate propagation characteristic, is not assigned with any transmission data in the first signal transmission device 4, the latter part of the process takes place.

In contrast, when the reception power of the target subcarrier is not greater than the first reference value, the determination, at S3 is negatively made that the propagation characteristic in the first antenna 4d with respect to the target subcarrier is inadequate. Then, at S7, the reception power in the second antenna 5d with respect to the target subcarrier is monitored in the second RF device 5c. Then at S8, a second comparison determination is made as to whether the reception power of the monitored target subcarrier is greater than a second reference value in the propagation characteristic determination device 7, to thereby make a determination as to whether the propagation characteristic in the second antenna 5d with respect to the target subcarrier is adequate.

When the reception power of the target subcarrier is greater than the second reference value, the determination at S8 is affirmatively made that the propagation characteristic in the second antenna 5d with respect to the target subcarrier is adequate. Then at S9, a data assignment control is made in the diversity control circuit 8 such that transmission data is outputted to the second signal transmission device 5, thereby assigning the transmission data to the subcarrier, which is determined to have an adequate propagation characteristic, in the second signal transmission device 5. In contrast, when the reception power of the target subcarrier is not greater than the second reference value, the determination at S8 is negatively made that the propagation characteristic in the second antenna 5d with respect to the target subcarrier is inadequate. At S10, a data assignment control is made in the diversity control circuit 8 such that transmission data is outputted to the third signal transmission device 6, thereby assigning the transmission data to the subcarrier, which is determined not to have an adequate propagation characteristic in the second antenna 5d, in the third signal transmission device 6.

Thus, after assigning all the subcarriers with transmission data in one of the first signal transmission device 4, the second signal transmission device 5, and the third signal transmission device 6, a transmission signal containing the transmission data is transmitted from one of the first antenna 4d, the second antenna 5d, and the third antenna 6d at S11.

Thus, the transmission data is assigned to one of the subcarrier of the transmission signal transmitted from the first antenna 4d which is the horizontally polarized wave antenna, the subcarrier of the transmission signal transmitted from the second antenna 5d which is the horizontally polarized wave antenna, the subcarrier of the transmission signal transmitted from the third antenna 6d which is the vertically polarized wave antenna. The spatial diversity is made by using the first antenna 4d and the second antenna 5d; the polarization diversity is made by using the first antenna 4d, the second antenna 5d, and the vertically polarized wave antenna 6d.

That is, in the present embodiment, the propagation environment in the vehicle compartment provides a multi-path environment which is surrounded by a metal body. Especially the flat ceiling wall or surface is valid as a transmission route of reflection waves. Moreover, in the ultra wide band communications technology, the path loss in space is great. Hence, the reflection wave undergoing the reflections multiple times has a significantly long transmission route, thereby attenuating and hardly arriving. From such a situation, the present embodiment focuses on the following two points: in the vehicle compartment, the direct wave and the reflection wave reflected in the flat ceiling surface are dominant; no difference between the transmission and reception occurs in respect of polarization; and the horizontally polarized wave antenna generally has indirectionality in the direction of the elevation angle and it is easy to use the reflection route towards the direction of the ceiling. Thereby, the transmission signal is basically transmitted from the first antenna 4d being a horizontally polarized wave antenna. By assigning the transmission data also to the subcarrier which is determined to be inadequate in the propagation characteristic in the first antenna 4d, the transmission signal is transmitted from the second antenna 5d that is a horizontally polarized wave antenna or the third antenna 6d that is a vertically polarized wave antenna. The above results from the technical idea to raise the communications efficiency of the whole channel.

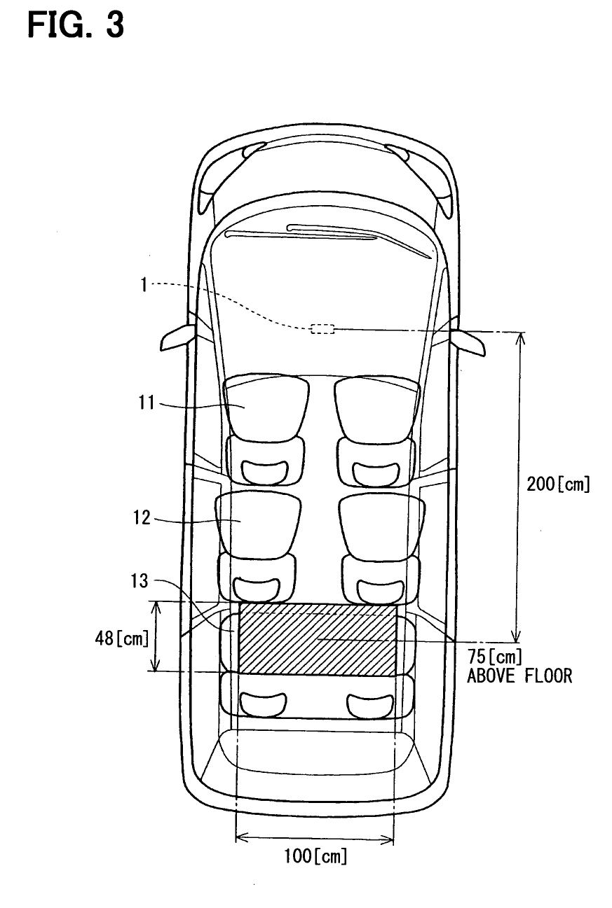

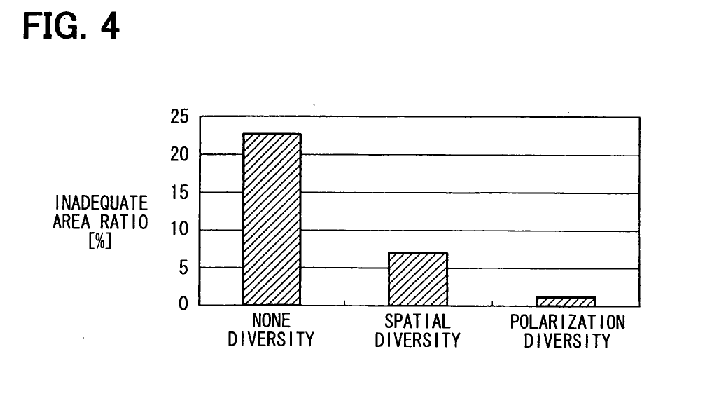

Next explains an advantage to improve the communications efficiency by adopting the present embodiment. FIG. 3 illustrates a measurement environment; FIG. 4 illustrates a measurement result. That is, the subject of the measurement environment is a vehicle compartment accommodating so-called three-row seats of a front row seat 11, an intermediate row seat 12, and a back row seat 13. The above-mentioned vehicle compartment wireless communications apparatus 1 (i.e., the first antenna 4d, the second antenna 5d, the third antenna 6d) is arranged near a dashboard, that is closer to the front of the vehicle than the front row seat 11; the communications apparatus, which is a communication partner of the wireless communications apparatus 1, is assumed to be positioned at the back row seat 13. The measurement range is rectangular and parallel with the floor of the vehicle compartment. The measurement range is further defined as follows. The distance from the vehicle compartment wireless communications apparatus 1 to the center of the measurement range (illustrated by hatching) is about 200 [cm]. The height of the measurement range from the vehicle compartment floor level is about 75 [cm]. The width in the longitudinal direction of the vehicle is about 48 [cm]; the width in the width direction of the vehicle is about 100 [cm]. The reception power is measured in all the area within the measurement range. Thus, an inadequate reception sensitivity area where the reception power greater than a reference value is not measured is determined; then, the ratio of the inadequate reception sensitivity area to all the area of the measurement range is calculated.

With reference to FIG. 4, “NONE DIVERSITY” signifies the case that the transmission signal is transmitted only from the first antenna 4d, i.e., without spatial diversity and polarization diversity. “SPATIAL DIVERSITY” signifies the case that the transmission signal is transmitted from the first antenna 4d and the second antenna 5d while executing the spatial diversity. “POLARIZATION DIVERSITY” signifies the case that the transmission signal is transmitted from the first antenna 4d and the third antenna 6d while executing the polarization diversity. As clearly understood from FIG. 4, the configuration executing the spatial diversity provides the ratio of the inadequate reception sensitivity area remarkably lower than the configuration not executing any diversity does; moreover, the configuration executing the polarization diversity provides the ratio of the inadequate reception sensitivity area still more remarkably lower than the configuration not executing any diversity. Thus, the configuration of the embodiment can improve the communications efficiency.

The above-mentioned configuration has two horizontally polarized wave antennas of the first antenna 4d and the second antenna 5d and one vertically polarized wave antenna of the third antenna 6d; however, another configuration may be adopted which has more than two horizontally polarized wave antennas, or has more than one vertically polarized wave antenna. Further, yet another configuration may be adopted which combines in various manners more than two horizontally polarized wave antennas and more than one vertically polarized wave antenna. Moreover, in the above configuration, when it is determined that a target subcarrier has not an adequate propagation characteristic in the first antenna 4d, it is then determined whether the target subcarrier has an adequate propagation characteristic in the second antenna 5d that is another horizontally polarized wave antenna. That is, the second antenna 5d that is a horizontally polarized wave antenna is prioritized in determining the propagation characteristic; in contrast, it may be determined whether the target subcarrier has an adequate propagation characteristic in the third antenna 6d that is a vertically polarized wave antenna. That is, the third antenna 6d that is a vertically polarized wave antenna can be prioritized in determining the propagation characteristic.

As explained above, in the vehicle compartment wireless communications apparatus 1 according to the embodiment, the following configuration is provided. The propagation characteristic in the first antenna 4d of a horizontally polarized wave antenna is determined with respect to each of several subcarriers. Of several subcarriers, the subcarrier, which is determined to be adequate in the propagation characteristic in the first antenna 4d, is assigned with the transmission data in the first antenna 4d; thereby, the transmission signal containing the transmission data is transmitted from the first antenna 4d. In contrast, of the several subcarrier, the subcarrier, which is determined to be inadequate in the propagation characteristic in the first antenna 4d, is also assigned with the transmission data in either the second antenna 5d of a horizontally polarized wave antenna or the third antenna 6d of a vertically polarized wave antenna; thereby, the transmission signal containing the transmission data is transmitted from the second antenna 5d that is a horizontally polarized wave antennas or the third antenna 6d that is a vertically polarized wave antenna. Thus, the spatial diversity is executed by using the first antenna 4d and the second antenna 5d; the polarization diversity is executed by using the first antenna 4d or second antenna 5d, and the third antenna 6d. Such a configuration does not generate a subcarrier assigned with no transmission data while executing the spatial diversity and polarization diversity. The frequency resource can be thus effectively used without wasted subcarriers, thereby improving the communications efficiency of the whole channel appropriately.

Moreover, executing of the polarization diversity may have an advantage as follows. When the communications apparatus of the communications partner is a portable communications terminal brought into the vehicle compartment, the position or direction where the user uses the terminal cannot be easily specified. Further, the terminal might be a vertically polarized wave antenna. Even in such a case, executing of the polarization diversity can improve the communications efficiency of the whole channel appropriately.

Furthermore, the first antenna 4d, the second antenna 5d, and the third antenna 6d are configured to have the directionality towards the ceiling of the vehicle. The propagation route can thus pass through a space between the internal wall of the ceiling of the vehicle and the occupant who gets in the vehicle compartment, thereby helping prevent the loss due to the occupant to further improve the propagation characteristic. Moreover, reflecting in the ceiling of the vehicle can lengthen the propagation route, thereby expanding the communications area.

The present invention is not limited only to the above-mentioned embodiment, and can be modified or extended as follows. The vehicle compartment wireless communications apparatus may not be limited to the in-vehicle navigation apparatus having the navigation function, but an in-vehicle handsfree apparatus having a handsfree function or an in-vehicle handsfree-functioned navigation apparatus having both a handsfree function and a navigation function.

Each or any combination of processes, functions, sections, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

Aspects of the disclosure described herein are set out in the following clauses.

As an aspect of the disclosure, a vehicle compartment wireless communications apparatus for executing ultra wide band communications is provided in a vehicle compartment having a flat internal ceiling wall made of a metal material. The vehicle compartment wireless communications apparatus is provided as follows. At least two horizontally polarized wave antennas are configured to include a first horizontally polarized wave antenna and a second horizontally polarized wave antenna. At least one vertically polarized wave antenna is configured. A propagation characteristic determination device is configured to determine whether each of a plurality of subcarriers included in one channel of an ultra wide band has an adequate propagation characteristic. A transmission unit is configured to assign a subcarrier with transmission data so as to transmit a transmission signal containing the transmission data from one of the antennas. Herein, the propagation characteristic determination device is further configured to determine whether each of the plurality of subcarriers has an adequate propagation characteristic in the first horizontally polarized wave antenna. The transmission unit is further configured to assign a subcarrier, which is determined to have an adequate propagation characteristic in the first horizontally polarized wave antenna among the plurality of subcarriers, with transmission data so as to transmit a transmission signal containing the transmission data from the first horizontally polarized wave antenna, and assign a subcarrier, which is determined not to have an adequate propagation characteristic in the first horizontally polarized wave antenna among the plurality of subcarriers, with transmission data so as to transmit a transmission signal containing the transmission data from one of the second horizontally polarized wave antenna and the vertically polarized wave antenna. The transmission unit thereby executes diversity by (i) the first horizontally polarized wave antenna and (ii) one of the second horizontally polarized wave antenna and the vertically polarized wave antenna.

As an optional aspect of the above vehicle compartment wireless communications apparatus, the propagation characteristic determination device may be further configured to determine whether each of a group of subcarriers, which are determined not to have an adequate propagation characteristic in the first horizontally polarized wave antenna among the plurality of subcarriers, has an adequate propagation characteristic in the second horizontally polarized wave antenna. The transmission unit may be further configured to assign a subcarrier, which is determined to have an adequate propagation characteristic in the second horizontally polarized wave antenna in the group of subcarriers, with transmission data so as to transmit a transmission signal containing the transmission data from the second horizontally polarized wave antenna. The transmission unit may thereby execute spatial diversity by the first horizontally polarized wave antenna and the second horizontally polarized wave antenna.

Under such a configuration to execute the spatial diversity, the frequency resource can be effectively used without waste, thereby improving the communications efficiency of the whole channel appropriately.

Further, as a further optional aspect of the foregoing vehicle compartment wireless communications apparatus, the transmission unit may be further configured to assign a subcarrier, which is determined not to have an adequate propagation characteristic in the second horizontally polarized wave antenna among the group of subcarriers, with transmission data so as to transmit a transmission signal containing the transmission data from the vertically polarized wave antenna. The transmission unit may thereby execute spatial diversity by (i) the first horizontally polarized wave antenna and (ii) the second horizontally polarized wave antenna, while executing polarization diversity by (i) the first horizontally polarized wave antenna and the second horizontally polarized wave antenna and (ii) the vertically polarized wave antenna.

Thus, by executing both the spatial diversity and polarization diversity, the frequency resource can be thus effectively used without waste, thereby improving the communications efficiency of the whole channel appropriately. That is, when the communications apparatus of the communications partner is a portable communications terminal (mobile terminal) brought into the vehicle compartment, the position or direction where the user uses the terminal cannot be easily specified. Further, the terminal may not be certainly determined to be not a vertically polarized wave antenna. Even in such a case, executing of the polarization diversity can improve the communication efficiency of the whole channel appropriately.

As another optional aspect of the vehicle compartment wireless communications apparatus, the propagation characteristic determination device may be further configured to determine whether each of a group of subcarriers, which are determined not to have an adequate propagation characteristic in the first horizontally polarized wave antenna among the plurality of subcarriers, has an adequate propagation characteristic in the vertically polarized wave antenna. The transmission unit may be further configured to assign a subcarrier, which is determined to have an adequate propagation characteristic in the vertically polarized wave antenna among the group of subcarriers so as to transmit a transmission signal containing the transmission data from the vertically polarized wave antenna, thereby executing polarization diversity by (i) the first horizontally polarized wave antenna and (ii) the vertically polarized wave antenna.

Under such a configuration to execute the polarization diversity, the frequency resource can be effectively used without waste, thereby improving the communications efficiency of the whole channel appropriately. That is, when the communications apparatus of the communications partner is a portable communications terminal brought into the vehicle compartment, the position or direction where the user uses the terminal cannot be easily specified. Further, the terminal may not be certainly determined to be not a vertically polarized wave antenna. Even in such a case, executing of the polarization diversity can improve the communication efficiency of the whole channel appropriately.

Further, as a further optional aspect of foregoing vehicle compartment wireless communications apparatus, the transmission unit may be further configured to assign a subcarrier, which is determined not to have an adequate propagation characteristic in the vertically horizontally polarized wave antenna among the group of subcarriers, with transmission data so as to transmit a transmission signal containing the transmission data from the second horizontally polarized wave antenna, thereby executing polarization diversity by (i) the first horizontally polarized wave antenna and the second horizontally polarized wave antenna and (ii) the vertically polarized wave antenna, while executing spatial diversity by (i) the first horizontally polarized wave antenna and (ii) the second horizontally polarized wave antenna.

Under such a configuration to execute both the spatial diversity and the polarization diversity, the frequency resource can be effectively used without waste, thereby improving the communications efficiency of the whole channel appropriately.

As another optional aspect of the vehicle compartment wireless communications apparatus, the first horizontally polarized wave antenna, the second horizontally polarized wave antenna, and the vertically polarized wave antenna may have directionality directed towards a ceiling of the vehicle compartment.

The propagation route can thus pass through a space between (i) the internal wall of the ceiling of the vehicle and (ii) the occupant who gets in the vehicle compartment, thereby helping prevent the loss due to the occupant to further improve the propagation characteristic. Moreover, reflecting in the ceiling of the vehicle can lengthen the propagation route, thereby expanding the communications area.

It will be obvious to those skilled in the art that various changes may be made in the above-described embodiments of the present invention. However, the scope of the present invention should be determined by the following claims.

What is claimed:

1. A vehicle compartment wireless communications apparatus for executing ultra wide band communications in a vehicle compartment having a flat internal ceiling wall made of a metal material,
the apparatus comprising:
at least two horizontally polarized wave antennas including a first horizontally polarized wave antenna and a second horizontally polarized wave antenna;
at least one vertically polarized wave antenna;
a propagation characteristic determination device to determine whether each of a plurality of subcarriers included in one channel of an ultra wide band has an adequate propagation characteristic; and
a transmission unit to assign a subcarrier with transmission data so as to transmit a transmission signal containing the transmission data from one of the antennas,
the propagation characteristic determination device being further configured to determine whether each of the plurality of subcarriers has an adequate propagation characteristic in the first horizontally polarized wave antenna,
the transmission unit being further configured to
assign a subcarrier, which is determined to have an adequate propagation characteristic in the first horizontally polarized wave antenna among the plurality of subcarriers, with transmission data so as to transmit a transmission signal containing the transmission data from the first horizontally polarized wave antenna, and
assign a subcarrier, which is determined not to have an adequate propagation characteristic in the first horizontally polarized wave antenna among the plurality of subcarriers, with transmission data so as to transmit a transmission signal containing the transmission data from one of the second horizontally polarized wave antenna and the vertically polarized wave antenna,
the transmission unit thereby executing diversity by (i) the first horizontally polarized wave antenna and (ii) one of the second horizontally polarized wave antenna and the vertically polarized wave antenna.

2. The vehicle compartment wireless communications apparatus according to claim 1, wherein:
the propagation characteristic determination device is further configured to determine whether each of a group of subcarriers, which are determined not to have an adequate propagation characteristic in the first horizontally polarized wave antenna among the plurality of subcarriers, has an adequate propagation characteristic in the second horizontally polarized wave antenna; and
the transmission unit is further configured to
assign a subcarrier, which is determined to have an adequate propagation characteristic in the second horizontally polarized wave antenna in the group of subcarriers, with transmission data so as to transmit a transmission signal containing the transmission data from the second horizontally polarized wave antenna,
the transmission unit thereby executing spatial diversity by the first horizontally polarized wave antenna and the second horizontally polarized wave antenna.

3. The vehicle compartment wireless communications apparatus according to claim 2, wherein
the transmission unit is further configured to
assign a subcarrier, which is determined not to have an adequate propagation characteristic in the second horizontally polarized wave antenna among the group of subcarriers, with transmission data so as to transmit a transmission signal containing the transmission data from the vertically polarized wave antenna,
the transmission unit thereby executing spatial diversity by (i) the first horizontally polarized wave antenna and (ii) the second horizontally polarized wave antenna, while executing polarization diversity by (i) the first horizontally polarized wave antenna and the second horizontally polarized wave antenna and (ii) the vertically polarized wave antenna.

4. The vehicle compartment wireless communications apparatus according to claim 1, wherein:
the propagation characteristic determination device is further configured to determine whether each of a group of subcarriers, which are determined not to have an adequate propagation characteristic in the first horizontally polarized wave antenna among the plurality of subcarriers, has an adequate propagation characteristic in the vertically polarized wave antenna;
the transmission unit is further configured to
assign a subcarrier, which is determined to have an adequate propagation characteristic in the vertically polarized wave antenna among the group of subcarriers so as to transmit a transmission signal containing the transmission data from the vertically polarized wave antenna,
the transmission unit thereby executing polarization diversity by (i) the first horizontally polarized wave antenna and (ii) the vertically polarized wave antenna.

5. The vehicle compartment wireless communications apparatus according to claim 4, wherein
the transmission unit is further configured to
assign a subcarrier, which is determined not to have an adequate propagation characteristic in the vertically horizontally polarized wave antenna among the group of subcarriers, with transmission data so as to transmit a transmission signal containing the transmission data from the second horizontally polarized wave antenna,
the transmission unit thereby executing polarization diversity by (i) the first horizontally polarized wave antenna and the second horizontally polarized wave antenna and (ii) the vertically polarized wave antenna, while executing spatial diversity by (i) the first horizontally polarized wave antenna and (ii) the second horizontally polarized wave antenna.

6. The vehicle compartment wireless communications apparatus according to claim 1, wherein
the first horizontally polarized wave antenna, the second horizontally polarized wave antenna, and the vertically polarized wave antenna have directionality directed towards a ceiling of the vehicle compartment.

7. A method for executing ultra wide band communications using a channel of an ultra wide band containing a plurality of subcarriers in a vehicle compartment having a flat internal ceiling wall made of a metal material,
the ultra wide communications using (i) at least two horizontally polarized wave antennas including a first horizontally polarized wave antenna and a second horizontally polarized wave antenna, and (ii) at least one vertically polarized wave antenna,
the method comprising:
determining whether each of the plurality of subcarriers has an adequate propagation characteristic in the first horizontally polarized wave antenna;
assigning a subcarrier, which is determined to have an adequate propagation characteristic in the first horizontally polarized wave antenna among the plurality of subcarriers, with transmission data so as to transmit a transmission signal containing the transmission data from the first horizontally polarized wave antenna;
assigning a subcarrier, which is determined not to have an adequate propagation characteristic in the first horizontally polarized wave antenna among the plurality of subcarriers, with transmission data so as to transmit a transmission signal containing the transmission data from one of the second horizontally polarized wave antenna and the vertically polarized wave antenna; and
executing thereby diversity by (i) the first horizontally polarized wave antenna and (ii) one of the second horizontally polarized wave antenna and the vertically polarized wave antenna.
